(19) United States
(12) Patent Application Publication
(10) Pub. No.: US 2012/0022055 A1
(43) Pub. Date: Jan. 26, 2012

(54) PEST CONTROLLING COMPOSITION

(76) Inventors: Norihisa Sakamoto, Sanda-shi (JP); Shinya Nishimura, Yokohama-shi (JP)

(21) Appl. No.: 13/203,540

(22) PCT Filed: Feb. 24, 2010
(86) PCT No.: PCT/JP2010/053371

§ 371 Date: Oct. 11, 2011

(30) Foreign Application Priority Data
Feb. 26, 2009 (JP) 2009-043667

(51) Int. Cl. A01N 43/56; A01P 7/00; A01P 5/00; A01P 7/04; A01P 7/02; A01N 43/88; A01P 3/00

(52) U.S. Cl. 514/229.2; 514/341

(57) ABSTRACT

The present invention provides a pest controlling composition comprising, as active ingredients, an amide compound of the formula (I) and a neonicotinoid compound; and so on.

### TECHNICAL FIELD

The present invention relates to a pest controlling composition.

### BACKGROUND ART

Conventionally, a lot of compounds have been developed and put into practical use, for controlling pests (JP-A-2007-182422).

### DISCLOSURE OF INVENTION

An object of the present invention is to provide a composition for controlling pests and a method for controlling pests and so on, having an excellent effect for controlling pests.

The present invention provides a pest controlling composition comprising, as active ingredients, the following (A) and (B) (hereinafter, referred to as composition of the present invention, in some cases).

### (A) An Amide Compound of the Formula (I):

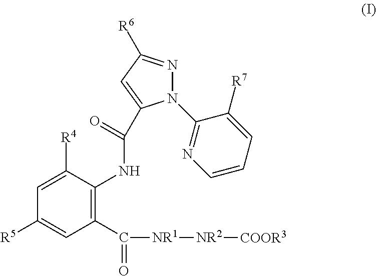

wherein, R¹ represents a C1-C6 alkyl group optionally substituted with at least one halogen atom, R² represents a hydrogen atom or a C1-C6 alkyl group optionally substituted with at least one halogen atom, R³ represents a C1-C6 alkyl group optionally substituted with at least one halogen atom, a C3-C6 alkoxyalkyl group optionally substituted with at least one halogen atom, a C3-C6 alkenyl group optionally substituted with at least one halogen atom or a C3-C6 alkynyl group optionally substituted with at least one halogen atom, R⁴ represents a halogen atom or a C1-C6 alkyl group optionally substituted with at least one halogen atom, R⁵ represents a hydrogen atom, a halogen atom, a cyano group or a C1-C6 alkyl group optionally substituted with at least one halogen atom, R⁶ represents a hydrogen atom, a halogen atom, a cyano group, a C1-C6 alkyl group optionally substituted with at least one halogen atom, a C1-C6 alkoxy group optionally substituted with at least one halogen atom, a C1-C6 alkylthio group optionally substituted with at least one halogen atom, a C1-C6 alkylsulfinyl group optionally substituted with at least one halogen atom or a C1-C6 alkylsulfonyl group optionally substituted with at least one halogen atom, and R⁷ represents a halogen atom or a C1-C6 alkyl group optionally substituted with at least one halogen atom.

### (B) A Neonicotinoid Compound.

Specifically, the present invention provides:

[1] a pest controlling composition comprising, as active ingredients, the following (A) and (B):

(A) An Amide Compound of the Formula (I):

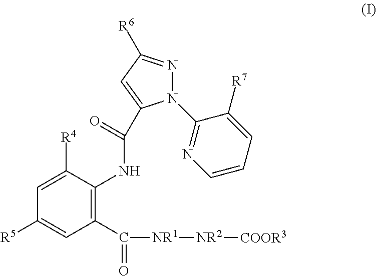

wherein, R¹ represents a C1-C6 alkyl group optionally substituted with at least one halogen atom, R² represents a hydrogen atom or a C1-C6 alkyl group optionally substituted with at least one halogen atom, R³ represents a C1-C6 alkyl group optionally substituted with at least one halogen atom, a C3-C6 alkoxyalkyl group optionally substituted with at least one halogen atom, a C3-C6 alkenyl group optionally substituted with at least one halogen atom or a C3-C6 alkynyl group optionally substituted with at least one halogen atom, R⁴ represents a halogen atom or a C1-C6 alkyl group optionally substituted with at least one halogen atom, R⁵ represents a hydrogen atom, a halogen atom, a cyano group or a C1-C6 alkyl group optionally substituted with at least one halogen atom, R⁶ represents a hydrogen atom, a halogen atom, a cyano group, a C1-C6 alkyl group optionally substituted with at least one halogen atom, a C1-C6 alkoxy group optionally substituted with at least one halogen atom, a C1-C6 alkylthio group optionally substituted with at least one halogen atom, a C1-C6 alkylsulfinyl group optionally substituted with at least one halogen atom or a C1-C6 alkylsulfonyl group optionally substituted with at least one halogen atom, and R⁷ represents a halogen atom or a C1-C6 alkyl group optionally substituted with at least one halogen atom; and

(B) A Neonicotinoid Compound;

[2] the pest controlling composition according to [1], wherein R¹ is an ethyl group, R² is a hydrogen atom, methyl group or ethyl group, R³ is a methyl group or ethyl group, R⁴ is a halogen atom or methyl group, R⁵ is a halogen atom or cyano group, R⁶ is a halogen atom or trifluoromethyl group and R⁷ is a halogen atom, in the formula (I);

[3] the pest controlling composition according to [1], wherein R¹ is an ethyl group, R² is a hydrogen atom, R³ is a methyl group, R⁴ is a methyl group, R⁵ is a cyano group, R⁶ is a bromine atom and R⁷ is a chlorine atom, in the formula (I);

[4] the pest controlling composition according to [1], wherein R¹ is an ethyl group, R² is an ethyl group, R³ is a methyl group, R⁴ is a bromine atom, R⁵ is a bromine atom, R⁶ is a bromine atom and R⁷ is a chlorine atom, in the formula (I);

[5] the pest controlling composition according to [1], wherein R¹ is an ethyl group, R² is a hydrogen atom, R³ is a methyl group, R⁴ is a bromine atom, R⁵ is a bromine atom, R⁶ is a bromine atom and R⁷ is a chlorine atom, in the formula (I);

[6] the pest controlling composition according to any one of [1] to [5], wherein the weight ratio of the component (A) to the component (B) is 10:90 to 90:10;

[7] the pest controlling composition according to any one of [1] to [6], wherein the neonicotinoid compound is at least one compound selected from the group consisting of clothianidin, nitenpyram, thiamethoxam, imidacloprid, acetamiprid, dinotefuran and thiacloprid;

[8] the pest controlling composition according to any one of [1] to [6], wherein the neonicotinoid compound is clothianidin or nitenpyram;

[9] a pest controlling method comprising applying an effective amount of the pest controlling composition as defined in any one of [1] to [8] to a pest, a habitat of a pest, or a plant body to be protected from damage by a pest;

[10] a pest controlling method comprising applying an effective amount of the pest controlling composition as defined in any one of [1] to [8] to a seed, seed tuber, bulb or parts around them of a plant to be protected from damage by a pest; and so on.

The present invention is capable of providing a pest controlling composition showing an excellent effect for controlling pests.

### MODES FOR CARRYING OUT THE INVENTION

The present invention will be described in detail below.

The component (A), that is, an amide compound of the formula (I):

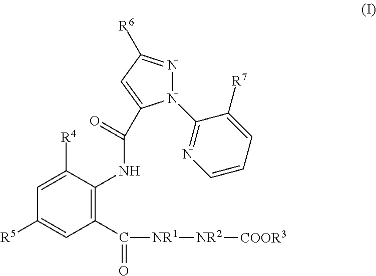

wherein, R¹ represents a C1-C6 alkyl group optionally substituted with at least one halogen atom, R² represents a hydrogen atom or a C1-C6 alkyl group optionally substituted with at least one halogen atom, R³ represents a C1-C6 alkyl group optionally substituted with at least one halogen atom, a C3-C6 alkoxyalkyl group optionally substituted with at least one halogen atom, a C3-C6 alkenyl group optionally substituted with at least one halogen atom or a C3-C6 alkynyl group optionally substituted with at least one halogen atom, R⁴ represents a halogen atom or a C1-C6 alkyl group optionally substituted with at least one halogen atom, R⁵ represents a hydrogen atom, a halogen atom, a cyano group or a C1-C6 alkyl group optionally substituted with at least one halogen atom, R⁶ represents a hydrogen atom, a halogen atom, a cyano group, a C1-C6 alkyl group optionally substituted with at least one halogen atom, a C1-C6 alkoxy group optionally substituted with at least one halogen atom, a C1-C6 alkylthio group optionally substituted with at least one halogen atom, a C1-C6 alkylsulfinyl group optionally substituted with at least one halogen atom or a C1-C6 alkylsulfonyl group optionally substituted with at least one halogen atom, and R⁷ represents a halogen atom or a C1-C6 alkyl group optionally substituted with at least one halogen atom; (hereinafter, referred to as amide compound (1) in some cases) will be explained.

For substituents represented by R¹ to R⁷ in the formula (I):

Examples of “halogen atom” include a fluorine atom, chlorine atom, bromine atom and iodine atom.

Examples of “C1-C6 alkyl group optionally substituted with at least one halogen atom” include a methyl group, trifluoromethyl group, trichloromethyl group, chloromethyl group, dichloromethyl group, fluoromethyl group, difluoromethyl group, ethyl group, pentafluoroethyl group, 2,2,2-trifluoroethyl group, 2,2,2-trichloroethyl group, propyl group, isopropyl group, heptafluoroisopropyl group, butyl group, isobutyl group, sec-butyl group, tert-butyl group, pentyl group and hexyl group.

Examples of “C3-C6 alkoxyalkyl group optionally substituted with at least one halogen atom” include a 2-methoxyethyl group, 2-ethoxyethyl group and 2-isopropyloxyethyl group.

Examples of “C2-C6 alkenyl group optionally substituted with at least one halogen atom” include a 2-propenyl group, 3-chloro-2-propenyl group, 2-chloro-2-propenyl group, 3,3-dichloro-2-propenyl group, 2-butenyl group, 3-butenyl group, 2-methyl-2-propenyl group, 3-methyl-2-butenyl group, 2-pentenyl group and 2-hexenyl group.

Examples of “C3-C6 alkynyl group optionally substituted with at least one halogen atom” include a 2-propynyl group, 3-chloro-2-propynyl group, 3-bromo-2-propynyl group, 2-butynyl group and 3-butynyl group.

Examples of “C1-C6 alkoxy group optionally substituted with at least one halogen atom” include a methoxy group, ethoxy group, 2,2,2-trifluoroethoxy group, propoxy group, isopropyloxy group, butoxy group, isobutyloxy group, sec-butoxy group and tert-butoxy group.

Examples of “C1-C6 alkylthio group optionally substituted with at least one halogen atom” include a methylthio group, trifluoromethylthio group, ethylthio group, propylthio group, isopropylthio group, butylthio group, isobutylthio group, sec-butylthio group, tert-butylthio group, pentylthio group and hexylthio group.

Examples of “C1-C6 alkylsulfinyl group optionally substituted with at least one halogen atom” include a methylsulfinyl group, trifluoromethylsulfinyl group, ethylsulfinyl group, propylsulfinyl group, isopropylsulfinyl group, butylsulfinyl group, isobutylsulfinyl group, sec-butylsulfinyl group, tert-butylsulfinyl group, pentylsulfinyl group and hexylsulfinyl group.

Examples of “C1-C6 alkylsulfonyl group optionally substituted with at least one halogen atom” include a methylsulfonyl group, trifluoromethylsulfonyl group, ethylsulfonyl group, propylsulfonyl group, isopropylsulfonyl group, butylsulfonyl group, isobutylsulfonyl group, sec-butylsulfonyl group, tert-butylsulfonyl group, pentylsulfonyl group and hexylsulfonyl group.

Embodiments of the amide compound (1) include, for example, compounds of the formula (I) in which R¹ is a hydrogen atom, methyl group, ethyl group or isopropyl group, R² is a hydrogen atom, methyl group or ethyl group, R³ is a methyl group or ethyl group, R⁴ is a halogen atom or methyl group, R⁵ is a halogen atom or cyano group, R⁶ is a halogen atom or trifluoromethyl group and R⁷ is a halogen atom. As the component (A), these compounds may be used singly, or a mixture of two amide compounds (1) may be used.

Preferable embodiments of the amide compound (1) include:

a compound of the formula (I) in which R¹ is a methyl group, R² is a methyl group, R³ is a methyl group, R⁴ is a chlorine atom, bromine atom or methyl group, R⁵ is a chlorine atom, bromine atom or cyano group, R⁶ is a chlorine atom, bromine atom or trifluoromethyl group and R⁷ is a chlorine atom;

a compound of the formula (I) in which R¹ is a methyl group, R² is a hydrogen atom, R³ is a methyl group, R⁴ is a chlorine atom, bromine atom or methyl group, R⁵ is a chlorine atom, bromine atom or cyano group, R⁶ is a chlorine atom, bromine atom or trifluoromethyl group and R⁷ is a chlorine atom;

a compound of the formula (I) in which R¹ is an ethyl group, R² is a hydrogen atom, R³ is a methyl group, R⁴ is a chlorine atom, bromine atom or methyl group, R⁵ is a chlorine atom, bromine atom or cyano group, R⁶ is a chlorine atom, bromine atom or trifluoromethyl group and R⁷ is a chlorine atom; and

a compound of the formula (I) in which R¹ is an ethyl group, R² is an ethyl group, R³ is a methyl group, R⁴ is a chlorine atom, bromine atom or methyl group, R⁵ is a chlorine atom, bromine atom or cyano group, R⁶ is a chlorine atom, bromine atom or trifluoromethyl group and R⁷ is a chlorine atom.

Specific examples of the amide compound (1) are shown in Tables 1 and 2.

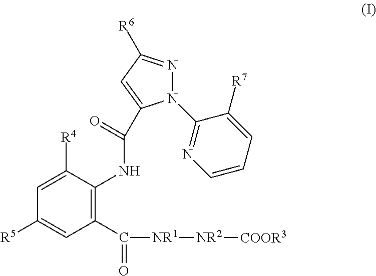

TABLE 1

| Com- | | | | | | | |
|---|---|---|---|---|---|---|---|
| pound | | | | | | | |
| No. | R¹ | R² | R³ | R⁴ | R⁵ | R⁶ | R⁷ |
| 1 | CH₃ | CH₃ | CH₃ | Br | Br | Br | Cl |
| 2 | CH₃CH₂ | H | CH₃ | Br | Br | Br | Cl |
| 3 | CH₃ | H | CH₃ | CH₃ | Cl | Br | Cl |
| 4 | CH₃ | H | CH₃ | Br | Br | Br | Cl |
| 5 | (CH₃)₂CH | H | CH₃ | Br | Br | Br | Cl |
| 6 | CH₃ | H | CH₃ | CH₃ | Cl | CF₃ | Cl |
| 7 | CH₃ | CH₃ | CH₃ | CH₃ | Cl | Br | Cl |
| 8 | CH₃ | H | CH₃ | CH₃ | CN | Br | Cl |
| 9 | CH₃ | CH₃ | CH₃ | CH₃ | CN | Br | Cl |
| 10 | CH₃ | H | CH₃ | Cl | Cl | Br | Cl |
| 11 | CH₃ | H | CH₃CH₂ | Cl | Cl | Br | Cl |
| 12 | CH₃ | CH₃ | CH₃ | Cl | Cl | Br | Cl |
| 13 | CH₃ | CH₃ | CH₃ | Br | Cl | Br | Cl |
| 14 | CH₃ | CH₃ | CH₃ | CH₃ | Cl | Cl | Cl |
| 15 | CH₃ | CH₃ | CH₃ | Cl | Cl | Cl | Cl |
| 16 | CH₃ | CH₃ | CH₃ | Br | Br | Cl | Cl |
| 17 | CH₃CH₂ | H | CH₃ | Cl | Cl | Br | Cl |
| 18 | CH₃ | CH₃ | CH₃ | Br | Br | CF₃ | Cl |
| 19 | CH₃(CH₂)₂ | H | CH₃ | Br | Br | Br | Cl |
| 20 | CH₃ | CH₃CH₂ | CH₃ | Br | Br | Br | Cl |
| 21 | CH₃CH₂ | CH₃ | CH₃ | Br | Br | Br | Cl |
| 22 | CH₃CH₂ | CH₃CH₂ | CH₃ | Br | Br | Br | Cl |
| 23 | CH₃CH₂ | H | CH₃ | CH₃ | Cl | Br | Cl |
| 24 | CH₃CH₂ | H | CH₃ | CH₃ | CN | Br | Cl |
| 25 | CH₃CH₂ | H | CH₃ | Br | Br | Cl | Cl |

TABLE 2

| Com- | | | | | | | |
|---|---|---|---|---|---|---|---|
| pound | | | | | | | |
| No. | R¹ | R² | R³ | R⁴ | R⁵ | R⁶ | R⁷ |
| 26 | CH₃CH₂ | H | CH₃ | Cl | Cl | Cl | Cl |
| 27 | CH₃CH₂ | H | CH₃ | CH₃ | Cl | Cl | Cl |
| 28 | CH₃CH₂ | H | CH₃ | CH₃ | CN | Cl | Cl |
| 29 | CH₃CH₂ | H | CH₃ | Br | Br | CF₃ | Cl |
| 30 | CH₃CH₂ | H | CH₃ | Cl | Cl | CF₃ | Cl |
| 31 | CH₃CH₂ | H | CH₃ | CH₃ | Cl | CF₃ | Cl |
| 32 | CH₃CH₂ | H | CH₃ | CH₃ | CN | CF₃ | Cl |
| 33 | CH₃ | H | CH₃ | Br | Br | CF₃ | Cl |
| 34 | CH₃ | H | CH₃ | Br | Br | Cl | Cl |
| 35 | CH₃CH₂ | CH₃CH₂ | CH₃ | CH₃ | CN | Br | Cl |
| 36 | CH₃ | H | CH₃ | Cl | Cl | Cl | Cl |
| 37 | CH₃ | H | CH₃ | CH₃ | Cl | Cl | Cl |
| 38 | CH₃ | H | CH₃ | CH₃ | CN | Cl | Cl |
| 39 | CH₃ | H | CH₃ | Cl | Cl | CF₃ | Cl |
| 40 | CH₃ | H | CH₃ | CH₃ | CN | CF₃ | Cl |
| 41 | CH₃ | CH₃ | CH₃ | CH₃ | CN | Cl | Cl |
| 42 | CH₃ | CH₃ | CH₃ | Cl | Cl | CF₃ | Cl |
| 43 | CH₃ | CH₃ | CH₃ | CH₃ | Cl | CF₃ | Cl |
| 44 | CH₃ | CH₃ | CH₃ | CH₃ | CN | CF₃ | Cl |

The amide compound (1) can be produced by methods described in JP-A No. 2007-182422 and JP-A No. 2008-280335.

The component (B), that is, a neonicotinoid compound will be described.

Examples of the neonicotinoid compound include clothianidin, nitenpyram, thiamethoxam, imidacloprid, acetamiprid, dinotefuran and thiacloprid. As the component (B), at least one compound selected from the group consisting of clothianidin, nitenpyram, thiamethoxam, imidacloprid, acetamiprid, dinotefuran and thiacloprid is preferable, and clothianidin or nitenpyram is more preferable.

Clothianidin (chemical name: (E)-1-(2-chloro-1,3-thiazol-5-ylmethyl)-3-methyl-2-nitroguanidine) can be produced by a method described in Japanese Patent No. 2546003, or correspondent methods.

Nitenpyram (chemical name: (E)-N-(6-chloro-3-pyridylmethyl)-N-ethyl-N′-methyl-2-nitrovinylidenediamine) can be produced by a method described in Japanese Patent No. 2122839, or correspondent methods.

Thiamethoxam (chemical name: 3-(2-chloro-1,3-thiazol-5-ylmethyl)-5-methyl-1,3,5-oxadiazinan-4-ylidene(nitro)amine) can be produced by a method described in Japanese Patent No. 3487614, or correspondent methods.

Imidacloprid (chemical name: 1-(6-chloro-3-pyridylmethyl)-N-nitroimidazolidin-2-ylideneamine) can be produced by a method described in Japanese Patent No. 1880961, or correspondent methods.

Acetamiprid (chemical name: (E)-N¹-[(6-chloro-3-pyridyl)methyl]-N²-cyano-N¹-methylacetamidine) can be produced by a method described in Japanese Patent No. 2926954, or correspondent methods.

Dinotefuran (chemical name: (RS)-1-methyl-2-nitro-3-(tetrahydro-3-furylmethyl)guanidine) can be produced by a method described in Japanese Patent No. 2766848, or correspondent methods.

Thiacloprid (chemical name: 3-(6-chloro-3-pyridylmethyl)-1,3-thiazolidin-2-ylidenecyanamide) can be produced by a method described in Japanese Patent No. 1985059, or correspondent methods.

For the component (A) and the component (B), geometric isomers and/or stereoisomers thereof may exist respectively, and the present invention includes these isomers and mixture of these isomers.

The component (A) and the component (B) may form agrichemically acceptable salts, respectively. Examples of these salts include salts with inorganic bases (for example, alkali metals such as sodium, potassium and lithium, alkaline earth metals such as calcium and magnesium, ammonia and so on), organic bases (for example, pyridine, collidine, triethylamine, triethanolamine and so on), inorganic acids (for example, hydrochloric acid, hydrobromic acid, hydroiodic acid, phosphoric acid, sulfuric acid, perchloric acid and so on), organic acids (for example, formic acid, acetic acid, tartaric acid, malic acid, citric acid, oxalic acid, succinic acid, benzoic acid, picric acid, methanesulfonic acid, p-toluenesulfonic acid and so on).

The composition of the present invention can be prepared into a dosage form such as emulsion agent, liquid agent, micro emulsion agent, flowable agent, oil agent, wettable powder agent, powder agent, granule agent, fine granule agent, seed coating agent, seed immersion agent, smoking agent, tablet agent, microcapsule agent, spray agent, aerosol agent, carbon dioxide gas preparation, EW agent, ointment, capsule agent, pellet agent, injection agent and coating agent, for example, by dissolving or dispersing the component (A) and the component (B) of the composition in a suitable liquid carrier, or mixing the components with or allowing the components to be adsorbed on a suitable solid carrier.

If necessary, for example, a gaseous carrier, ointment base, surfactant, or other additives may be added to these preparations, and these can be prepared by known methods.

Examples of the liquid carrier include water, alcohols (for example, methyl alcohol, ethyl alcohol, n-propyl alcohol, isopropyl alcohol, butyl alcohol, hexyl alcohol, benzyl alcohol, ethylene glycol, propylene glycol, phenoxyethanol and so on), ketones (for example, acetone, methyl ethyl ketone, methyl isobutyl ketone, cyclohexanone and so on), ethers (for example, diisopropyl ether, 1,4-dioxane, tetrahydrofuran, ethylene glycol monomethyl ether, ethylene glycol dimethyl ether, diethylene glycol monomethyl ether, propylene glycol monomethyl ether, dipropylene glycol monomethyl ether, 3-methoxy-3-methyl-1-butanol and so on), aliphatic hydrocarbons (for example, hexane, cyclohexane, kerosene, lamp oil, fuel oil, machine oil and so on), aromatic hydrocarbons (for example, toluene, xylene, ethylbenzene, dodecylbenzene, phenylxylylethane, solvent naphtha, methylnaphthalene and so on), halogenated hydrocarbons (for example, dichloromethane, trichloroethane, chloroform, carbon tetrachloride and so on), acid amides (for example, N,N-dimethylformamide, N,N-dimethylacetamide, N-methylpyrrolidone, N-octylpyrrolidone and so on), esters (for example, butyl lactate, ethyl acetate, butyl acetate, isopropyl myristate, ethyl oleate, diisopropyl adipate, diisobutyl adipate, propylene glycol monomethyl ether acetate, fatty acid glycerin ester, γ-butyrolactone and so on), nitriles (for example, acetonitrile, isobutyronitrile, propionitrile and so on), carbonates (for example, propylene carbonate and so on), vegetable oils (for example, soybean oil, olive oil, linseed oil, coconut oil, palm oil, peanut oil, malt oil, almond oil, sesame oil, mineral oil, rosmarinic oil, geranium oil, rapeseed oil, cotton seed oil, corn oil, safflower oil, orange oil and so on), etc. and these liquid carriers may be mixed at suitable proportion and used (preferably, one or more and three or less are used).

Examples of the solid carrier (dilution agent, extending agent) include plant powders (for example, soybean flour, tobacco flour, wheat flour, wood flour and so on), mineral powders (for example, clays such as kaolin clay, Fubasami clay, bentonite and acid clay, talcs such as talc powder and agalmatolite powder, silicas such as white carbon, diatomaceous earth and mica powder, and so on), synthetic hydrated silicon oxide, alumina, talc, ceramic, other inorganic minerals (sericite, quartz, sulfur, active carbon, calcium carbonate, hydrated silica and so on) and chemical fertilizers (ammonium sulfate, ammonium phosphate, ammonium nitrate, urea, ammonium chloride) in the form of fine powder and granule, and these solid carriers may be mixed at suitable proportion and used (preferably, one or more and three or less are used).

As the gaseous carrier which can be used in the above-described preparations, for example, fluorocarbon, butane gas, LPG (liquefied petroleum gas), dimethyl ether and carbon dioxide gas are mentioned, and these gaseous carriers can be used singly or two of them can be mixed in suitable proportion, or can be combined with a suitable liquid carrier, and used.

Examples of the ointment base include polyethylene glycol, pectine, polyhydric alcohol esters of higher fatty acids (for example, monostearic acid glycerin ester and so on), cellulose derivatives (for example, methylcellulose and so on), sodium alginate, bentonite, higher alcohols, polyhydric alcohols (for example, glycerin and so on), vaseline, white vaseline, liquid paraffin, lard, various vegetable oils, lanolin, dehydrated lanolin, hardened oil, resins and so on, and these ointment bases may be used in combination (preferably, one or more and three or less are used), or surfactants shown below can be added to them.

Examples of the surfactant include nonionic and anionic surfactants such as soaps, polyoxyethylene alkyl aryl ethers (for example, Noigen (product name, registered trademark, manufactured by Dai-Ichi Kogyo Seiyaku Co., Ltd.), EA142 (EA142 (product name, manufactured by Dai-Ichi Kogyo Seiyaku Co., Ltd.)), Nonal (product name, manufactured by Toho Chemical Industry Co., Ltd.)), polyoxyethylene tristyrylphenyl ether phosphoric acid (for example, Soprophor (registered trademark) FLK (product name, manufactured by Rhodia Nikka Co., Ltd.)), alkylsulfates (for example, Emal 10 (product name, registered trademark, manufactured by Kao Corporation), Emal 40 (product name, registered trademark, manufactured by Kao Corporation), sodium lauryl sulfate), alkylbenzene sulfonates (for example, Neogen (product name, registered trademark, manufactured by Dai-Ichi Kogyo Seiyaku Co., Ltd.), Neogen T (product name, registered trademark, manufactured by Dai-Ichi Kogyo Seiyaku Co., Ltd.), Neopelex (product name, registered trademark, manufactured by Kao Corporation), BC2070M (product name, manufactured by TAYCA Corporation)), polyethylene glycol ethers (for example, Nonipole 85 (product name, registered trademark, manufactured by Sanyo Chemical Industries, Ltd.), Nonipole 100 (product name, registered trademark, manufactured by Sanyo Chemical Industries, Ltd.), Nonipole 160 (product name, registered trademark, manufactured by Sanyo Chemical Industries, Ltd.)), polyoxyethylene alkyl ethers (for example, Noigen ET-135 (product name, registered trademark, manufactured by Dai-Ichi Kogyo Seiyaku Co., Ltd.)), polyoxyethylene polyoxypropylene block polymers (for example, Newpole PE-64 (product name, registered trademark, manufactured by Sanyo Chemical Industries, Ltd.)), polyhydric alcohol esters (for example, Tween 20 (product name, registered trademark, manufactured by Kao Corporation), Tween 80 (product name, registered trademark, manufactured by Kao Corporation)), alkylsulfosuccinates (for example, Sanmorin OT20 (product name, registered trademark, manufactured by Sanyo Chemical Industries, Ltd.), Newcalgen EX70 (product name, manufactured by TAKEMOTO Oil & Fat Co., Ltd.)), alkyl aryl sulfonates (for example, Newcalgen WG-1 (product name, manufactured by TAKEMOTO Oil & Fat Co., Ltd.), Morwet EFW (product name, manufactured by DESOTO, Inc.), alkenyl sulfonates (for example, Sorpole 5115 (product name, registered trademark, manufactured by Toho Chemical Industry Co., Ltd.)) and calcium lignin sulfonate, and these surfactants can be mixed in suitable proportion and used (preferably, one or more and three or less are used).

Examples of the other additives include casein, gelatin, saccharides (starch, xanthan gum, gum arabic, cellulose derivatives, alginic acid and so on), lignin derivatives, bentonite, synthetic water-soluble polymers (polyvinyl alcohol, polyvinyl pyrrolidone, polyacrylic acids and so on), PAP (acidic isopropyl phosphate), BHT (2,6-di-tert-butyl-4-methylphenol), BHA (mixture of 2-tert-butyl-4-methoxyphenol and 3-tert-butyl-4-methoxyphenol), aluminum magnesium silicate, dyes (for example, FLEXIVERSE (registered trademark, product name, manufactured by Sun Chemical)), preservatives (for example, Proxel (registered trademark) GXL (product name, manufactured by Arch Chemicals Inc.)), emulsifiers (for example, sorbitan trioleate), defoaming agents (for example, Antifoam C Emulsion (product name, registered trademark; manufactured by Dow Corning)), dispersing agents (for example, Morwet D425 (product name, manufactured by AkzoNobel)) and so on.

In the composition of the present invention, the weight ratio of the component (A) to the component (B) is usually 1:99 to 99:1, preferably 10:90 to 90:10, more preferably 30:70 to 60:40.

The content of additives other than the above-described active ingredients varies depending on the kind or content of the active ingredients, or the form of the preparation, and it is usually about 0.001 to 99.9 wt %, preferably about 1 to 99 wt %. More specifically, it is desirable to add a surfactant in an amount of usually about 1 to 30 wt %, preferably about 1 to 15 wt %, a flow aid in an amount of usually about 1 to 20 wt %, a carrier in an amount of usually about 1 to 90 wt %, preferably about 1 to 70 wt %, with respect to the total amount of the composition. In the case of production of a liquid agent, it is desirable to add a surfactant in an amount of usually about 1 to 20 wt %, preferably about 1 to 10 wt % and water in an amount of about 20 to 90 wt %. In the case of production of an emulsion agent, it is desirable to add a surfactant in an amount of usually 1 to 30 wt %, preferably 2 to 15 wt % and an organic solvent. In the case of production of a granule wettable powder agent, it is desirable to add a surfactant in an amount of usually 0.1 to 10 wt %, preferably 0.5 to 5 wt %, a binder in an amount of usually 0.1 to 15 wt %, preferably 0.5 to 5 wt %, and an extending agent such as lactose, ammonium sulfate and orclay. In the case of production of a granule agent, it is desirable to add a surfactant in an amount of usually 0.1 to 10 wt %, preferably 0.5 to 5 wt %, a stabilizer in an amount of usually 0.1 to 10 wt %, preferably 0.5 to 5 wt %, and an extending agent such as clay. In the case of production of a Jumbo agent, it is desirable to add a surfactant in an amount of usually 0.1 to 15 wt %, preferably 0.5 to 5 wt %, a binder in an amount of usually 0.5 to 10 wt %, preferably 0.5 to 5 wt %, a floatation agent in an amount of usually 0.5 to 40 wt %, preferably 1 to 20 wt %, and an extending agent such as clay.

In use of the composition of the present invention, for example, the component (A) and the component (B) are applied in a proportion of usually 0.001 to 1000 g, preferably 0.01 to 100 g per 1000 m² of the application area. When the composition of the present invention is prepared into an emulsion agent, wettable powder agent, flowable agent, microcapsule agent or the like, the composition is diluted with water so as to give a concentration of the component (A) and the component (B) of usually 0.001 to 10000 ppm, preferably 0.01 to 500 ppm and applied, and when prepared into a granule agent, powder agent or the like, the composition is applied as it is.

Examples of the use method of the composition of the present invention include a spray treatment, soil treatment, seed treatment and hydroponic liquid treatment.

The spray treatment means, specifically, a treatment method in which pests harming a plant are controlled by treating the plant surface itself with an active ingredient, such as foliar spray, trunk spray, for example.

The soil treatment means, for example, a treatment method in which the root zone of a crop plant is treated with an active ingredient to exert a controlling effect directly on pests present in the root zone, or an active ingredient is allowed to permeate and transfer into a plant body through a root part or the like, thereby manifesting a controlling effect on pests harming the plant, and specific examples thereof include planting hole application (planting hole spraying, planting hole soil incorporation), plant foot application (plant foot spraying, plant foot soil incorporation, plant foot drenching, plant foot application at a later seedling raising stage), planting furrow application (planting furrow spraying, planting furrow soil incorporation), planting row application (planting row spraying, planting row soil incorporation, planting row spraying at a growing stage), planting row application at sowing (planting row spraying at sowing, planting row soil incorporation at sowing), broadcast application (overall soil surface spraying, overall soil incorporation), side row application, water surface applications (water surface application, post-flooding water surface application), other soil spray applications (granule agent leaf surface spraying at a growing stage, spraying under tree canopy or around main trunk, soil surface spraying, soil surface incorporation, sowing hole spraying, levee surface spraying, inter-planting spraying), other drench application (soil drenching, drenching at a seedling raising stage, drug liquid injection application, plant foot drenching, chemical drip irrigation, chemigation), nursery box application (nursery box spraying, nursery box soil drenching, nursery box chemical liquid flooding), nursery tray application (nursery tray spraying, nursery tray soil drenching, nursery tray chemical liquid flooding), nursery bed application (nursery bed spraying, nursery bed drenching, lowland nursery bed spraying, seedling immersion), bed soil incorporation application (bed soil incorporation, presowing bed soil incorporation, spraying before sowing and soil covering, spraying after sowing and soil covering, cover soil incorporation), other treatments (nursery soil incorporation, plowing, topsoil incorporation, soil incorporation under canopy edge, planting position application, granule agent flower cluster spraying, paste fertilizer incorporation).

The seed treatment means, for example, a treatment method in which an active ingredient is applied directly to crop seeds, seed tuber or bulb, or parts around them, thereby manifesting a controlling effect on pests harming the plant, and specific examples thereof include a spray treatment, smear treatment, immersion treatment, impregnation treatment, coating treatment, film coat treatment and pellet coat treatment.

The hydroponic liquid treatment means, for example, a treatment method in which an active ingredient is added to a hydroponic liquid and the like for allowing the active ingredient to permeate and transfer into a plant body of a crop plant through a root part or the like, thereby manifesting a controlling effect on pests harming the plant, and specific examples thereof include hydroponic liquid incorporation and hydroponic liquid interfusion.

The composition of the present invention may contain other pest controlling active ingredients, for example, insecticides (for example, pyrethroid insecticide, organophosphorus insecticide, carbamate insecticide, nerve sodium channel blocker, insecticidal macrocyclic lactone, γ-aminobutyric acid (GABA) antagonist, calcium channel activator, urea insecticide, insect hormone mimic, natural insecticide and so on), acaricide, nematocide, herbicide, plant hormone, other plant growth regulators, fungicides (for example, copper fungicide, organic chlorine fungicide, organic sulfur fungicide, phenol fungicide and so on), synergist, attractant, repellent, drug adverse effect mitigating agent, dye, fertilizer, and soil improving agent.

Examples of such insecticide, fungicide, acaricide, nematocide, fungicide, and herbicide which may be contained in the composition of the present invention will be described below.

Examples of the insecticide (insecticidal active ingredient) include the following (1) to (12).

### (1) Organic Phosphorus Compounds

Acephate, aluminium phosphide, butathiofos, cadusafos, chlorethoxyfos, chlorfenvinphos, chlorpyrifos, chlorpyrifos-methyl, cyanophos:CYAP, diazinon, DCIP (dichlorodiisopropyl ether), dichlofenthion:ECP, dichlorvos:DDVP, dimethoate, dimethylvinphos, disulfoton, EPN, ethion, ethoprophos, etrimfos, fenthion:MPP, fenitrothion:MEP, fosthiazate, formothion, hydrogen phosphide, isofenphos, isoxathion, malathion, mesulfenfos, methidathion:DMTP, monocrotophos, naled:BRP, oxydeprofos:ESP, parathion, phosalone, phosmet:PMP, pirimiphos-methyl, pyridafenthion, quinalphos, phenthoate:PAP, profenofos, propaphos, prothiofos, pyraclorfos, salithion, sulprofos, tebupirimfos, temephos, tetrachlorvinphos, terbufos, thiometon, trichlorphon:DEP, vamidothion, phorate, cadusafos, and so on.

### (2) Carbamate Compounds

Alanycarb, bendiocarb, benfuracarb, BPMC, carbaryl, carbofuran, carbosulfan, cloethocarb, ethiofencarb, fenobucarb, fenothiocarb, fenoxycarb, furathiocarb, isoprocarb:MIPC, metolcarb, methomyl, methiocarb, NAC, oxamyl, pirimicarb, propoxur: PHC, XMC, thiodicarb, xylylcarb, aldicarb, and so on.

### (3) Synthetic Pyrethroid Compounds

Acrinathrin, allethrin, benfluthrin, beta-cyfluthrin, bifenthrin, cycloprothrin, cyfluthrin, cyhalothrin, cypermethrin, deltamethrin, esfenvalerate, ethofenprox, fenpropathrin, fenvalerate, flucythrinate, flufenoprox, flumethrin, fluvalinate, halfenprox, imiprothrin, permethrin, prallethrin, pyrethrins, resmethrin, sigma-cypermethrin, silafluofen, tefluthrin, tralomethrin, transfluthrin, tetramethrin, phenothrin, cyphenothrin, alpha-cypermethrin, zeta-cypermethrin, lambda-cyhalothrin, gamma-cyhalothrin, furamethrin, tau-fluvalinate, metofluthrin, profluthrin, dimefluthrin, 2,3,5,6-tetrafluoro-4-(methoxymethyl)benzyl (EZ)-(1RS,3RS; 1RS,3SR)-2,2-dimethyl-3-prop-1-enylcyclopropanecarboxylate, 2,3,5,6-tetrafluoro-4-methylbenzyl (EZ)-(1RS,3RS; 1RS,3SR)-2,2-dimethyl-3-prop-1-enylcyclopropanecarboxylate, 2,3,5,6-tetrafluoro-4-(methoxymethyl)benzyl (1RS,3RS; 1RS,3SR)-2,2-dimethyl-3-(2-methyl-1-propenyl)cyclopropanecarboxylate, and so on.

### (4) Nereistoxin Compounds

Cartap, bensultap, thiocyclam, monosultap, bisultap, and so on.

### (5) Benzoylurea Compounds

Chlorfluazuron, bistrifluoron, diafenthiuron, diflubenzuron, fluazuron, flucycloxuron, flufenoxuron, hexaflumuron, lufenuron, novaluron, noviflumuron, teflubenzuron, triflumuron, triazuron, and so on.

### (6) Phenylpyrazole Compounds

Acetoprole, ethiprole, fipronil, vaniliprole, pyriprole, pyrafluprole, and so on.

### (7) Bt Toxin Insecticides

Viable endospores and crystalline toxins derived from Bacillus thuringiensis, and a mixture thereof.

### (8) Hydrazine Compounds

Chromafenozide, halofenozide, methoxyfenozide, tebufenozide, and so on.

### (9) Organic Chlorine Compounds

Aldrin, dieldrin, chlordane, DDT, dienochlor, endosulfan, methoxychlor, and so on.

### (10) Natural Insecticides

Machine oil, nicotine-sulfate, and so on.

### (11) Other Insecticides

Avermectin-B, bromopropylate, buprofezin, chlorphenapyr, cyantraniliprole, cyromazine, 1,3-Dichloropropene, emamectin-benzoate, fenazaquin, flupyrazofos, hydroprene, methoprene, indoxacarb, metoxadiazone, milbemycin-A, pymetrozine, pyridalyl, pyriproxyfen, spinosad, sulfluramid, tolfenpyrad, triazamate, flubendiamide, lepimectin, arsenic acid, benclothiaz, calcium cyanamide, calcium polysulfide, chlordane, DDT, DSP, flufenerim, flonicamid, flurimfen, formetanate, metam-ammonium, metam-sodium, Methyl bromide, nidinotefuran, Potassium oleate, protrifenbute, spiromesifen, sulfur, metaflumizone, spirotetramat, pyrifluquinazone, spinetoram, chlorantraniliprole, tralopyril, and so on.

Examples of the acaricide (acaricidal active ingredient) include acequinocyl, amitraz, benzoximate, bifenazate, bromopropylate, chinomethionat, chlorobenzilate, CPCBS (chlorfenson), clofentezine, cyflumetofen, kelthane(dicofol), etoxazole, fenbutatin oxide, fenothiocarb, fenpyroximate, fluacrypyrim, fluproxyfen, hexythiazox, propargite:BPPS, polynactins, pyridaben, pyrimidifen, tebufenpyrad, tetradifon, spirodiclofen, spiromesifen, spirotetramat, amidoflumet and cyenopyrafen.

Examples of the nematocide (nematocidal active ingredient) include DCIP, fosthiazate, levamisol, methylsothiocyanate, morantel tartarate and imicyafos.

Examples of the fungicide (fungicidal active ingredient) include:

fungicidal azole compounds such as propiconazole, ipconazole, prothioconazole, triadimenol, prochloraz, penconazole, tebuconazole, flusilazole, diniconazole, bromuconazole, epoxiconazole, difenoconazole, cyproconazole, metconazole, triflumizole, tetraconazole, myclobutanil, fenbuconazole, hexaconazole, fluquinconazole, triticonazole, bitertanol, imazalil and flutriafol;
fungicidal cyclic amine compounds such as fenpropimorph, tridemorph and fenpropidin;
fungicidal benzimidazole compounds such as carbendezim, benomyl, thiabendazole and thiophanate-methyl;
tolclofosmethyl, procymidone, cyprodinil, pyrimethanil, diethofencarb, thiuram, fluazinam, mancozeb, iprodione, vinclozolin, chlorothalonil, captan, mepanipyrim, fenpiclonil, fludioxonil, dichlofluanid, folpet, kresoxim-methyl, azoxystrobin, trifloxystrobin, fluoxastrobin, picoxystrobin, pyraclostrobin, dimoxystrobin, pyribencarb, spiroxamine, quinoxyfen, fenhexamid, famoxadone, fenamidone, zoxamide, ethaboxam, amisulbrom, iprovalicarb, benthiavalicarb, cyazofamid, mandipropamid, boscalid, penthiopyrad, metrafenone, fluopiran, bixafen, cyflufenamid, 2-[2-(2,5-dimethylphenoxymethyl)phenyl]-2-methoxy-N-methylacetamide and proquinazid.

Examples of the herbicide (herbicidal active ingredient) include flumiclorac-pentyl, flumioxazin, pyraflufen-ethyl, clethodim, pyrazosulfuron-ethyl, sulfosulfuron and bispyribac-sodium.

The above-described “other pest controlling active ingredients” are all known agricultural chemical active ingredients. The other pest controlling active ingredients may be contained singly or in combination (preferably, one or more and three or less are contained) in the composition. Examples of specific combination are shown below. In the examples below, the compounds (1) to (44) correspond to compound numbers described in Tables 1 and 2 mentioned above.

Any of compounds (1) to (44), clothianidin and ipconazole;

Any of compounds (1) to (44), clothianidin and metconazole;

Any of compounds (1) to (44), clothianidin and ethaboxam;

Any of compounds (1) to (44), clothianidin and 2-[2-(2,5-dimethylphenoxymethyl)phenyl]-2-methoxy-N-methyl-acetamide;

Any of compounds (1) to (44), clothianidin and tolclofosmethyl;

Any of compounds (1) to (44), nitenpyram and ipconazole;

Any of compounds (1) to (44), nitenpyram and metconazole;

Any of compounds (1) to (44), nitenpyram and ethaboxam;

Any of compounds (1) to (44), nitenpyram and 2-[2-(2,5-dimethyl-phenoxymethyl)phenyl]-2-methoxy-N-methyl-acetamide;

Any of compounds (1) to (44), nitenpyram and tolclofosmethyl;

Any of compounds (1) to (44), thiamethoxam and tolclofosmethyl;

Any of compounds (1) to (44), thiamethoxam and ipconazole;

Any of compounds (1) to (44), thiamethoxam and metconazole;

Any of compounds (1) to (44), thiamethoxam and ethaboxam;

Any of compounds (1) to (44), thiamethoxam and 2-[2-(2,5-dimethyl-phenoxymethyl)phenyl]-2-methoxy-N-methyl-acetamide;

Any of compounds (1) to (44), thiamethoxam and tolclofosmethyl;

Any of compounds (1) to (44), imidacloprid and ipconazole;

Any of compounds (1) to (44), imidacloprid and metconazole;

Any of compounds (1) to (44), imidacloprid and ethaboxam;

Any of compounds (1) to (44), imidacloprid and 2-[2-(2,5-dimethyl-phenoxymethyl)phenyl]-2-methoxy-N-methyl-acetamide;

Any of compounds (1) to (44), imidacloprid and tolclofosmethyl;

Any of compounds (1) to (44), thiacloprid and ipconazole;

Any of compounds (1) to (44), thiacloprid and metconazole;

Any of compounds (1) to (44), thiacloprid and ethaboxam;

Any of compounds (1) to (44), thiacloprid and 2-[2-(2,5-dimethyl-phenoxymethyl)phenyl]-2-methoxy-N-methyl-acetamide;

Any of compounds (1) to (44), thiacloprid and tolclofosmethyl;

Any of compounds (1) to (44), dinotefuran and ipconazole;

Any of compounds (1) to (44), dinotefuran and metconazole;

Any of compounds (1) to (44), dinotefuran and ethaboxam;

Any of compounds (1) to (44), dinotefuran and 2-[2-(2,5-dimethyl-phenoxymethyl)phenyl]-2-methoxy-N-methyl-acetamide;

Any of compounds (1) to (44), dinotefuran and tolclofosmethyl;

Any of compounds (1) to (44), acetamiprid and ipconazole;

Any of compounds (1) to (44), acetamiprid and metconazole;

Any of compounds (1) to (44), acetamiprid and ethaboxam;

Any of compounds (1) to (44), acetamiprid and 2-[2-(2,5-dimethyl-phenoxymethyl)phenyl]-2-methoxy-N-methyl-acetamide;

Any of compounds (1) to (44), acetamiprid and tolclofosmethyl; and so on.

The composition of the present invention can be used as a pest controlling agent for protecting plants in agricultural lands such as fields, rice fields, lawns and orchards or in non-agricultural lands.

Examples of the plant to be protected include the following plants.

Crops:

corn, rice, wheat, barley, rye, oat, sorghum, cotton, soybean, peanut, buckwheat, beet, rapeseed, sunflower, sugar cane, tobacco, and so on.

Vegetables:

solanaceous vegetables such as eggplant, tomato, pimento, pepper and potato;
cucurbitaceous vegetables such as cucumber, pumpkin, zucchini, water melon, melon and squash;
cruciferous vegetables such as Japanese radish, white turnip, horseradish, kohlrabi, Chinese cabbage, cabbage, leaf mustard, broccoli and cauliflower;
asteraceous vegetables such as burdock, crown daisy, artichoke and lettuce;
liliaceous vegetables such as green onion, onion, garlic and asparagus;
ammiaceous vegetables such as carrot, parsley, celery and parsnip; chenopodiaceous vegetables such as spinach and Swiss chard;
lamiaceous vegetables such as Perilla frutescens, mint and basil;
strawberry, sweet potato, Dioscorea japonica, colocasia, and so on.

Fruits:

pomaceous fruits such as apple, pear, Japanese pear, Chinese quince and quince;
stone fleshy fruits such as peach, plum, nectarine, Prunus mume, cherry fruit, apricot and prune;
citrus fruits such as Citrus unshiu, orange, lemon, rime and grapefruit;
nuts such as chestnuts, walnuts, hazelnuts, almond, pistachio, cashew nuts and macadamia nuts;
berries such as blueberry, cranberry, blackberry and raspberry;
grape, kaki fruit, olive, Japanese plum, banana, coffee, date palm, coconuts, oil palm, and so on.

Trees Other than Fruit Trees:

tea, mulberry, flowering plant,
roadside trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea and Taxus cuspidate;

### Jatropha, and so on.

Grasses:

zoysia such as Zoysia japonica and Zoysia matrella;
bermudagrass (Cynodon) such as Cynodon dactylon;
bentgrass (Agrostis) such as Agrostis alba, Agrostis stolonifera L., Agrostis tenuis Sibth.;
bluegrass (Poa) such as Poa pratensis L. and Poa trivialis L.; fesucue (Festuca) such as Festuca arundinacea Schreb., Festuca rubra L. var. commutata Gaud. and Festuca rubra L. var. genuina Hack;
ryegrass (Lolium) such as Lolium multiflorum and Lolium perenne;
Dactylis glomerata; Phleum pratense; and so on.

Others:

bio-fuel plants such as Jatropha curcas, safflower, Camelina, switch grass, Miscanthus giganteus, Phalaris arundinacea L., Arundo donax, Kenaf (Hibiscus cannabinus), cassava (Manihot esculenta), Salicaceae and algae;
flowers; ornamental foliage plant; and so on.

The aforementioned “plants” include plants, to which tolerance to HPPD inhibitors such as isoxaflutole, ALS inhibitors such as imazethapyr and thifensulfuron-methyl, EPSP synthetase inhibitors such as glyphosate, glutamine synthetase inhibitors such as glufosinate, acetyl-CoA carboxylase inhibitors such as sethoxydim, PPO inhibitors such as flumioxazin, and herbicides such as bromoxynil, dicamba and 2,4-D has been conferred by a classical breeding method or by genetic engineering techniques.

Examples of a “plant” on which tolerance has been conferred by a classical breeding method include rape, wheat, sunflower and rice tolerant to imidazolinone ALS inhibitory herbicides such as imazethapyr, which are already commercially available under a product name of Clearfield (registered trademark). Similarly, there is a soybean on which tolerance to sulfonylurea ALS inhibitory herbicides such as thifensulfuron-methyl has been conferred by a classical breeding method, which is already commercially available under a product name of STS soybean.

Examples of a plant on which tolerance to acetyl-CoA carboxylase inhibitors such as trione oxime or aryloxy phenoxypropionic acid herbicides has been conferred by a classical breeding method include SR corn. The plant on which tolerance to acetyl-CoA carboxylase inhibitors has been conferred is described in Proceedings of the National Academy of Sciences of the United States of America (Proc. Natl. Acad. Sci. USA), vol. 87, pp. 7175-7179 (1990). A variation of acetyl-CoA carboxylase tolerant to an acetyl-CoA carboxylase inhibitor is reported in Weed Science, vol. 53, pp. 728-746 (2005) and a plant tolerant to acetyl-CoA carboxylase inhibitors can be generated by introducing a gene of such an acetyl-CoA carboxylase variation into a plant by genetically engineering technology, or by introducing a variation conferring tolerance into a plant acetyl-CoA carboxylase.

Examples of a plant on which resistance has been conferred by a classical breeding method include crops resistant to nematode or aphid. Examples of a gene that leads to aphid-resistant phenotype include RAG1 gene.

Plants tolerant to acetyl-CoA carboxylase inhibitors or ALS inhibitors or the like can be generated by introducing into the plant cell a nucleic acid for introduction of base-substitution variation represented by Chimeraplasty Technique (Gura T. 1999. Repairing the Genome's Spelling Mistakes. Science 285: 316-318) to introduce a site-directed amino acid substitution variation into an acetyl-CoA carboxylase gene or an ALS gene of the plant.

Examples of a plant on which tolerance has been conferred by genetic engineering technology include corn, soybean, cotton, rape and sugar beet which are tolerant to glyphosate, and which have been commercially available under a product name of RoundupReady (registered trademark), AgrisureGT, and so on. There are corn, soybean, cotton and rape which are made tolerant to glufosinate by genetic engineering technology, which have been commercially available under a product name of LibertyLink (registered trademark). A cotton made tolerant to bromoxynil by genetic engineering technology has been commercially available under a product name of BXN.

The aforementioned “plants” include crops genetically engineered to be able to synthesize selective toxins as known in genus Bacillus.

Examples of toxins expressed in such genetically engineered crops include: insecticidal proteins derived from Bacillus cereus or Bacillus popilliae; δ-endotoxins derived from Bacillus thuringiensis such as Cry1Ab, Cry1Ac, Cry1F, Cry1Fa2, Cry2Ab, Cry3A, Cry3Bb1 or Cry9C; insecticidal proteins such as VIP1, VIP2, VIP3 or VIP3A; insecticidal proteins derived from nematodes; toxins generated by animals, such as scorpion toxin, spider toxin, bee toxin, or insect-specific neurotoxins; mold fungi toxins; plant lectin; agglutinin; protease inhibitors such as a trypsin inhibitor, a serine protease inhibitor, patatin, cystatin, or a papain inhibitor; ribosome-inactivating proteins (RIP) such as lycine, corn-RIP, abrin, luffin, saporin, or briodin; steroid-metabolizing enzymes such as 3-hydroxysteroid oxidase, ecdysteroid-UDP-glucosyl transferase, or cholesterol oxidase; an ecdysone inhibitor; HMG-COA reductase; ion channel inhibitors such as a sodium channel inhibitor or calcium channel inhibitor; juvenile hormone esterase; a diuretic hormone receptor; stilbene synthase; bibenzyl synthase; chitinase; and glucanase.

Toxins expressed in such genetically engineered crops also include: hybrid toxins of δ-endotoxin proteins such as Cry1Ab, Cry1Ac, Cry1F, Cry1Fa2, Cry2Ab, Cry3A, Cry3Bb1, Cry9C, Cry34Ab or Cry35Ab and insecticidal proteins such as VIP1, VIP2, VIP3 or VIP3A; partially deleted toxins; and modified toxins. Such hybrid toxins are produced from a new combination of the different domains of such proteins, by using a genetic engineering technique. As a partially deleted toxin, Cry1Ab comprising a deletion of a portion of an amino acid sequence has been known. A modified toxin is produced by substitution of one or multiple amino acids of natural toxins.

Examples of such toxins and genetically engineered plants capable of synthesizing such toxins are described in EP-A-0 374 753, WO 93/07278, WO 95/34656, EP-A-0 427 529, EP-A-451 878, WO 03/052073, and so on.

Toxins contained in such genetically engineered plants are able to confer resistance particularly to insect pests belonging to Coleoptera, Hemiptera, Diptera, Lepidoptera and Nematodes, to the plants.

Genetically engineered plants, which comprise one or multiple insecticidal pest-resistant genes and which express one or multiple toxins, have already been known, and some of such genetically engineered plants have already been on the market. Examples of such genetically engineered plants include YieldGard (registered trademark) (a corn variety for expressing Cry1Ab toxin), YieldGard Rootworm (registered trademark) (a corn variety for expressing Cry3Bb1 toxin), YieldGard Plus (registered trademark) (a corn variety for expressing Cry1Ab and Cry3Bb1 toxins), Herculex I (registered trademark) (a corn variety for expressing Cry1Fa2 toxin and phosphinotricine N-acetyl transferase (PAT) so as to confer tolerance to glufosinate), NuCOTN33B (registered trademark) (a cotton variety for expressing Cry1Ac toxin), Bollgard I (registered trademark) (a cotton variety for expressing Cry1Ac toxin), Bollgard II (registered trademark) (a cotton variety for expressing Cry1Ac and Cry2Ab toxins), VIPCOT (registered trademark) (a cotton variety for expressing VIP toxin), NewLeaf (registered trademark) (a potato variety for expressing Cry3A toxin), NatureGard (registered trademark) Agrisure (registered trademark) GT Advantage (GA21 glyphosate-tolerant trait), Agrisure (registered trademark) CB Advantage (Bt11 corn borer (CB) trait), and Protecta (registered trademark).

The aforementioned “plants” also include crops produced by using a genetic engineering technique, which have ability to generate antipathogenic substances having selective action.

A PR protein and the like have been known as such antipathogenic substances (PRPs, EP-A-0 392 225). Such antipathogenic substances and genetically engineered crops that generate them are described in EP-A-0 392 225, WO 95/33818, EP-A-0 353 191, etc.

Examples of such antipathogenic substances expressed in genetically engineered crops include: ion channel inhibitors such as a sodium channel inhibitor or a calcium channel inhibitor, among which KP1, KP4 and KP6 toxins produced by viruses have been known; stilbene synthase; bibenzyl synthase; chitinase; glucanase; a PR protein; and antipathogenic substances generated by microorganisms, such as a peptide antibiotic, an antibiotic having a hetero ring and a protein factor associated with resistance to plant diseases (which is called a plant disease-resistant gene and is described in WO 03/000906). These antipathogenic substances and genetically engineered plants producing such substances are described in EP-A-0392225, WO95/33818, EP-A-0353191, and so on.

The “plant” mentioned above includes plants on which advantageous characters such as characters improved in oil stuff ingredients or characters having reinforced amino acid content have been conferred by genetically engineering technology. Examples thereof include VISTIVE (registered trademark) low linolenic soybean having reduced linolenic content) or high-lysine (high-oil) corn (corn with increased lysine or oil content).

The composition of the present invention has a high pest controlling activity against various kinds of harmful organisms (including also Arthropod other than Insecta) while maintaining excellent safeness for mammals and crops.

The harmful organisms on which the composition of the present invention exerts an effect include, for example, arthropod such as insects and mites, and nemathelminth such as nematode, and specifically, those shown below.

Hemiptera:

planthoppers (Delphacidae) such as small brown planthopper (Laodelphax striatellus), brown rice planthopper (Nilaparvata lugens) and white-backed rice planthopper (Sogatella furcifera);
leafhoppers (Deltocephalidae) such as green rice leafhopper (Nephotettix cincticeps) and green rice leafhopper (Nephotettix virescens);
aphids (Aphididae) such as cotton aphid (Aphis gossypii), green peach aphid (Myzus persicae), cabbage aphid (Brevicoryne brassicae), foxglove aphid (Macrosiphum euphorbiae), potato aphid (Aulacorthum solani), oat bird-cherry aphid (Rhopalosiphum padi) and tropical citrus aphid (Toxoptera citricidus);
stink bugs (Pentatomidae) such as green stink bug (Nezara antennata), bean bug (Riptortus clavetus), rice bug (Leptocorisa chinensis), white spotted spined bug (Eysarcoris parvus), stink bug (Halyomorpha mista) and tarnished plant bug (Lygus lineolaris);
whiteflies (Aleyrodidae) such as greenhouse whitefly (Trialeurodes vaporariorum), sweetpotato whitefly (Bemisia tabaci) and silver leaf whitefly (Bemisia argentifolii);
scales (Coccidae) such as Calfornia red scale (Aonidiella aurantii), San Jose scale (Comstockaspis perniciosa), citrus north scale (Unaspis citri), red wax scale (Ceroplastes rubens), cottonycushion scale (Icerya purchasi) and comstock mealybug (Pseudococcus comstocki);
lace bugs (Tingidae); psyllids (Psyllidae); and so on.

Lepidoptera:

Pyralid moths (Pyralidae) such as rice stem borer (Chilo suppressalis), yellow rice borer (Tryporyza incertulas), rice leafroller (Cnaphalocrocis medinalis), cotton leafroller (Notarcha derogata), Indian meal moth (Plodia interpunctella), oriental corn borer (Ostrinia furnacalis), European corn borer (Ostrinia nubilalis), cabbage webworm (Hellula undalis) and bluegrass webworm (Pediasia teterrellus);
owlet moths (Noctuidae) such as common cutworm (Spodoptera litura), beet armyworm (Spodoptera exigua), armyworm (Pseudaletia separata), cabbage armyworm (Mamestra brassicae), black cutworm (Agrotis ipsilon), beet semi-looper (Plusia nigrisigna), Thoricoplusia spp., Heliothis spp. and Helicoverpa spp.;
whites and sulfer butterflies (Pieridae) such as common white (Pieris rapae); tortricid moths (Tortricidae) such as Adoxophyes spp., oriental fruit moth (Grapholita molesta), soybean pod borer (Leguminivora glycinivorella), azuki bean podworm (Matsumuraeses azukivora), summer fruit tortrix (Adoxophyes orana fasciata), Adoxophyes spp., oriental tea tortrix (Homona magnanima), apple tortrix (Archips fuscocupreanus) and Cydia pomonella;
leafblotch miners (Gracillariidae) such as tea leafroller (Caloptilia theivora) and apple leafminer (Phyllonorycter ringoneella);
Carposinidae such as peach fruit moth (Carposina niponensis); lyonetiid moths (Lyonetiidae) such as Lyonetia spp.; tussock moths (Lymantriidae) such as Lymantria spp. and Euproctis spp.;
yponomeutid moths (Yponomeutidae) such as diamondback (Plutella xylostella);
gelechiid moths (Gelechiidae) such as pink bollworm (Pectinophora gossypiella) and potato tubeworm (Phthorimaea operculella);
tiger moths and allies (Arctiidae) such as fall webworm (Hyphantria cunea);
tineid moths (Tineidae) such as casemaking clothes moth (Tinea translucens) and webbing clothes moth (Tineola bisselliella); and so on.

Diptera:

Culex spp. such as common mosquito (Culex pipiens pallens), Culex tritaeniorhynchus and Culex quinquefasciatus;
Aedes spp. such as yellow-fever mosquito (Aedes aegypti) and tiger mosquito (Aedes albopictus);
Anopheles spp. such as Anopheles sinensis;

### Chironomidae;

house flies (Muscidae) such as housefly (Musca domestica) and false housefly (Muscina stabulans);
blow flies (Calliphoridae);
flesh flies (Sarcophagidae);
little houseflies (Fanniidae),
anthomyiid flies (Anthomyiidae) such as seedcorn maggot (Delia platura) and onion maggot (Delia antiqua);
fruit flies (Tephritidae) such as melon fly (Dacus cucurbitae) and Mediterranean fruit fly (Ceratitis capitata);
vinegar flies (Drosophilidae);
moth flies (Psychodidae);
black flies (Simuliidae),
breeze flies (Tabanidae) such as horsefly (Tabanus trigonus);
stable flies (Stomoxyidae);
leafminer flies (Agromyzidae) such as rice leafminer (Agromyza oryzae), smaller rice leafminer (Hydrellia griseola), rice stem maggot (Chlorops oryzae), legume leafminer (Liriomyza trifolii) and tomato leafminer (Liriomyza sativae); and so on.

Coleoptera:

Twenty-eight-spotted ladybird (Epilachna vigintioctopunctata), cucurbit leaf beetle (Aulacophora femoralis), striped flea beetle (Phyllotreta striolata), rice leaf beetle (Oulema oryzae), rice curculio (Echinocnemus squameus), rice water weevil (Lissorhoptrus oryzophilus), Anthonomus grandis, azuki bean weevil (Callosobruchus chinensis), Sphenophorus venatus, Japanese beetle (Popillia japonica), cupreous chafer (Anomala cuprea), corn root worm (Diabrotica spp.), Colorado beetle (Leptinotarsa decemlineata), click beetle (Agriotes spp.), cigarette beetle (Lasioderma serricorne), varied carper beetle (Anthrenus verbasci), red flour beetle (Tribolium castaneum), powder post beetle (Lyctus brunneus), white-spotted longicorn beetle (Anoplophora malasiaca), pine shoot beetle (Tomicus piniperda), and so on.

Thysanoptera:

Thrips (Thripidae) such as yellow citrus thrips (Frankliniella occidentalis), Thrips parmi, yellow tea thrips (Scirtothrips dorsalis), onion thrip (Thrips tabaci), flower thrips (Frankliniella intonsa), tabacco thrips (Frankliniella fusca), and so on.

Hymenoptera:

Cabbage sawfly (Athalia rosae), Acromyrmex spp., fire ant (Solenopsis spp.), and so on.

Orthoptera:

Asiatic locust (Locusta migratoria), African mole cricket (Gryllotalpa africana), rice grasshopper (Oxya yezoensis), rice grasshopper (Oxya japonica), and so on.

Siphonaptera:

human flea (Pulex irritans) and so on.

Anoplura:

body louse (Pediculus humanus) and so on.

Isoptera:

### Termitidae and so on.

Dictyoptera:

Blattellidae such as German cockroach (Blattella germanica);
Blattidae such as smokybrown cockroach (Periplaneta fuliginosa), American cockroach (Periplaneta americana), brown cockroach (Periplaneta brunnea), oriental cockroach (Blatta orientalis); and so on.

Acarina:

Spider mites (Tetranychidae) such as two-spotted spider mite (Tetranychus urticae), Kanzawa spider mite (Tetranychus kanzawai), citrus red mite (Panonychus citri), European red mite (Panonychus ulmi) and Oligonychus spp.;

eriophyid mites (Eriophyidae) such as pink citrus rust mite (Aculops pelekassi) and apple rust mite (Aculus schlechtendali);
tarosonemid mites (Tarsonemidae) such as broad mite (Polyphagotarsonemus latus);
false spider mites (Tenuipalpidae); Tuckerellidae; ticks (Ixodidae) such as Haemaphysalis longicornis, Haemaphysalis flava, Dermacentor taiwanicus, Ixodes ovatus, Ixodes persulcatus and Boophilus microplus;
acarid mites (Acaridae) such as mold mite (Tyrophagus putrescentiae);
house dust mites (Pyroglyphidae) such as Dermatophagoides farinae and Dermatophagoides ptrenyssnus;
cheyletide mites (Cheyletidae) such as Cheyletus eruditus, Cheyletus malaccensis and Cheyletus moorei;
parasitoid mites (Dermanyssidae); and so on.

Nematodes:

coffee root-lesion nematode (Pratylenchus coffeae), chrysanthemum root-lesion nematode (Pratylenchus fallax), soybean cyst nematode (Heterodera glycines), potato cyst nematode (Globodera rostochiensis), northern root-knot nematode (Meloidogyne hapla), southern root-knot nematode (Meloidogyne incognita), Rice white-tip nematode (Aphelenchoides besseyi), strawberry bud nematode (Nothotylenchus acris) and so on.

### EXAMPLES

The present invention will be illustrated further in detail by formulation examples, seed treatment examples and test examples shown below, but the present invention is not limited only to the following examples. In the following examples, the part represents part by weight unless otherwise stated. The compounds (1) to (44) correspond to compound numbers described in Tables 1 and 2 mentioned above.

### Formulation Example 1

Any of the compounds (1) to (44) (2.5 parts), 1.25 parts of clothianidin, 2.5 parts of metconazole, 14 parts of polyoxyethylene styryl phenyl ether, 6 parts of calcium dodecylbenzenesulfonate and 73.75 parts of N-methylpyrrolidone are well mixed to obtain respective emulsions.

### Formulation Example 2

Five (5) parts of any of the compounds (1) to (44), 5 parts of clothianidin, 5 parts of ethaboxam, 35 parts of a mixture of white carbon and polyoxyethylene alkyl ether sulfate ammonium salt (weight ratio 1:1) and 50 parts of water are mixed, and the mixture is subjected to fine grinding according to a wet grinding method, to obtain respective flowable formulations.

### Formulation Example 3

Five (5) parts of any of the compounds (1) to (44), 10 parts of clothianidin, 5 parts of 2-[2-(2,5-dimethylphenoxymethyl)phenyl]-2-methoxy-N-methylacetamide, 1.5 parts of sorbitan trioleate, and 28.5 parts of an aqueous solution containing 2 parts of polyvinyl alcohol are mixed, and the mixture is subjected to fine grinding according to a wet grinding method. Thereafter, 40 parts of an aqueous solution containing 0.05 parts of xanthan gum and 0.1 part of aluminum magnesium silicate is added to the resultant mixture, and 10 parts of propylene glycol is further added thereto. The obtained mixture is blended by stirring to obtain respective flowable formulations.

### Formulation Example 4

Five (5) parts of any of the compounds (1) to (44), 20 parts of clothianidin, 5 parts of Rhizorex (tolclofosmethyl), 1.5 parts of sorbitan trioleate, and 28.5 parts of an aqueous solution containing 2 parts of polyvinyl alcohol are mixed, and the mixture is subjected to fine grinding according to a wet grinding method. Thereafter, 30 parts of an aqueous solution containing 0.05 parts of xanthan gum and 0.1 part of aluminum magnesium silicate is added to the resultant mixture, and 10 parts of propylene glycol is further added thereto. The obtained mixture is blended by stirring to obtain respective flowable formulations.

### Formulation Example 5

Forty (40) parts of any of the compounds (1) to (44), 5 parts of clothianidin, 5 parts of ipconazole, 5 parts of propylene glycol (manufactured by Nacalai Tesque Inc.), 5 parts of Soprophor (registered trademark) FLK (product name, manufactured by Rhodia Nikka Co., Ltd.), 0.2 parts of Antifoam C (registered trademark) Emulsion (product name, manufactured by Dow Corning), 0.3 parts of Proxel (registered trademark) GXL (product name, manufactured by Arch Chemicals Inc.) and 39.5 parts of ion exchange water are mixed to obtain a bulk slurry. To 100 parts of the slurry is added 150 parts of glass beads (diameter=1 mm), and the slurry is ground for 2 hours while being cooled with a cooling water. After ground, the resultant is filtered to remove the glass beads and respective flowable formulations are obtained.

### Formulation Example 6

Five (5) parts of any of the compounds (1) to (44), 5 parts of nitenpyram, 5 parts of ethaboxam, 35 parts of a mixture of white carbon and polyoxyethylene alkyl ether sulfate ammonium salt (weight ratio 1:1) and 50 parts of water are mixed, and the mixture is subjected to fine grinding according to a wet grinding method, to obtain respective flowable formulations.

### Formulation Example 7

Five (5) parts of any of the compounds (1) to (44), 10 parts of thiamethoxam, 5 parts of 2-[2-(2,5-dimethylphenoxymethyl)phenyl]-2-methoxy-N-methylacetamide, 1.5 parts of sorbitan trioleate, and 28.5 parts of an aqueous solution containing 2 parts of polyvinyl alcohol are mixed, and the mixture is subjected to fine grinding according to a wet grinding method. Thereafter, 40 parts of an aqueous solution containing 0.05 parts of xanthan gum and 0.1 part of aluminum magnesium silicate is added to the resultant mixture, and 10 parts of propylene glycol is further added thereto. The obtained mixture is blended by stirring to obtain respective flowable formulations.

### Formulation Example 8

Five (5) parts of any of the compounds (1) to (44), 20 parts of imidacloprid, 5 parts of tolclofos-methyl, 1.5 parts of sorbitan trioleate, and 28.5 parts of an aqueous solution containing 2 parts of polyvinyl alcohol are mixed, and the mixture is subjected to fine grinding according to a wet grinding method. Thereafter, 30 parts of an aqueous solution containing 0.05 parts of xanthan gum and 0.1 part of aluminum magnesium silicate is added to the resultant mixture, and 10 parts of propylene glycol is further added thereto. The obtained mixture is blended by stirring to obtain respective flowable formulations.

### Formulation Example 9

Fifty (50) parts of any of the compounds (1) to (44), 0.5 parts of thiamethoxam, 38.5 parts of NN kaolin clay (manufactured by Takehara Kagaku Kogyo Co., Ltd.), 10 parts of Morwet D425 (product name, manufactured by AkzoNobel) and 1.5 parts of Morwet EFW (product name, manufactured by DESOTO) are mixed, to obtain an AI premix. This premix is ground with a jet mill to obtain respective powders.

### Formulation Example 10

One (1) part of any of the compounds (1) to (44), 4 parts of thiamethoxam, 1 part of synthetic hydrated silicon oxide, 2 parts of calcium ligninsulfonate, 30 parts of bentonite and 62 parts of kaolin clay are fully ground and mixed, and the resultant mixture is added with water and fully kneaded, and then subjected to granulation and drying to obtain respective granules.

### Formulation Example 11

One (1) part of any of the compounds (1) to (44), 40 parts of imidacloprid, 3 parts of calcium ligninsulfonate, 2 parts of sodium laurylsulfate and 54 parts of synthetic hydrated silicon oxide are fully ground and mixed to obtain respective wettable powders.

### Formulation Example 12

One (1) part of any of the compounds (1) to (44), 2 parts of nitenpyram, 85 parts of kaolin clay and 10 parts of talc are fully ground and mixed to obtain respective powders.

### Formulation Example 13

Two (2) parts of any of the compounds (1) to (44), 0.25 parts of imidacloprid, 14 parts of polyoxyethylene styrylphenyl ether, 6 parts of calcium dodecylbenzenesulfonate and 77.75 parts N-methylpyrrolidone are fully mixed to obtain respective emulsions.

### Formulation Example 14

Ten (10) parts of any of the compounds (1) to (44), 2.5 parts of clothianidin, 1.5 parts of sorbitan trioleate, and 30 parts of an aqueous solution containing 2 parts of polyvinyl alcohol are mixed, and are subjected to fine grinding according to a wet grinding method. Thereafter, 47.5 parts of an aqueous solution containing 0.05 parts of xanthan gum and 0.1 parts of aluminum magnesium silicate is added to the ground solution, and 10 parts of propylene glycol is further added thereto. The obtained mixture is blended with stirring to obtain respective flowable formulations.

### Formulation Example 15

One (1) part of any of the compounds (1) to (44), 20 parts of clothianidin, 1 part of synthetic hydrated silicon oxide, 2 parts of calcium ligninsulfonate, 30 parts of bentonite and 47 parts of kaolin clay are fully ground and mixed, and the resultant mixture is added with water and fully kneaded, and then subjected to granulation and drying to obtain respective granules.

### Formulation Example 16

Forty (40) part of any of the compounds (1) to (44), 1 parts of nitenpyram, 3 parts of calcium ligninsulfonate, 2 parts of sodium laurylsulfate and 54 parts of synthetic hydrated silicon oxide are fully ground and mixed to obtain respective wettable powders.

### Formulation Example 17

Five (5) parts of any of the compounds (1) to (44), 5 parts of acetamiprid, 5 parts of ethaboxam, 35 parts of a mixture of white carbon and polyoxyethylene alkyl ether sulfate ammonium salt (weight ratio 1:1) and 50 parts of water are mixed, and the mixture is subjected to fine grinding according to a wet grinding method, to obtain respective flowable formulations.

### Formulation Example 18

Five (5) parts of any of the compounds (1) to (44), 5 parts of dinotefuran, 5 parts of ethaboxam, 35 parts of a mixture of white carbon and polyoxyethylene alkyl ether sulfate ammonium salt (weight ratio 1:1) and 50 parts of water are mixed, and the mixture is subjected to fine grinding according to a wet grinding method, to obtain respective flowable formulations.

### Formulation Example 19

Five (5) parts of any of the compounds (1) to (44), 5 parts of thiacloprid, 5 parts of ethaboxam, 35 parts of a mixture of white carbon and polyoxyethylene alkyl ether sulfate ammonium salt (weight ratio 1:1) and 50 parts of water are mixed, and the mixture is subjected to fine grinding according to a wet grinding method, to obtain respective flowable formulations.

Next, seed treatment examples will be shown.

### Seed Treatment Example 1

Using a rotary seed treatment machine (Seed Dresser, Manufactured by Hans-Ulrich Hege GmbH), 100 kg of dried Sorghum seeds are smeared with 500 ml of an emulsion containing any of the compounds (1) to (44) prepared as in Formulation example 1, to obtain treated seeds.

### Seed Treatment Example 2

Using a rotary seed treatment machine (Seed Dresser, Manufactured by Hans-Ulrich Hege GmbH), 10 kg of dried rape seeds are smeared with 50 ml of the flowable formulation containing any of the compounds (1) to (44) prepared as in Formulation example 2, to obtain treated seeds.

### Seed Treatment Example 3

Using a rotary seed treatment machine (Seed Dresser, Manufactured by Hans-Ulrich Hege GmbH), 10 kg of dried corn seeds are smeared with 40 ml of the flowable formulation containing any of the compounds (1) to (44) prepared as in Formulation example 3, to obtain treated seeds.

### Seed Treatment Example 4

Five (5) parts of an flowable formulation containing any of the compounds (1) to (44) prepared as in Formulation example 4, 5 parts of FLEXIVERSE (registered trademark, product name, Manufactured by Sun Chemical) and 35 parts of water are mixed to prepare a mixture. Using a rotary seed treatment machine (Seed Dresser, Manufactured by Hans-Ulrich Hege GmbH), 10 kg of dried rice seeds are smeared with 60 ml of the mixture, to obtain treated seeds.

### Seed Treatment Example 5

Five (5) parts of an flowable formulation containing any of the compounds (1) to (44) prepared as in Formulation example 4, 5 parts of FLEXIVERSE (registered trademark, product name, Manufactured by Sun Chemical) and 35 parts of water are mixed to prepare a mixture. Using a rotary seed treatment machine (Seed Dresser, Manufactured by Hans-Ulrich Hege GmbH), 10 kg of potato tuber fragments are smeared with 70 ml of the mixture, to obtain treated seeds.

### Seed Treatment Example 6

Using a rotary seed treatment machine (Seed Dresser, Manufactured by Hans-Ulrich Hege GmbH), 100 kg of dried sugar beet seeds are smeared with 500 ml of a flowable formulation containing any of the compounds (1) to (44) prepared as in Formulation example 7, to obtain treated seeds.

### Seed Treatment Example 7

Using a rotary seed treatment machine (Seed Dresser, Manufactured by Hans-Ulrich Hege GmbH), 10 kg of dried soybean seeds are smeared with 50 ml of a flowable formulation containing any of the compounds (1) to (44) prepared as in Formulation example 7, to obtain treated seeds.

### Seed Treatment Example 8

Using a rotary seed treatment machine (Seed Dresser, Manufactured by Hans-Ulrich Hege GmbH), 10 kg of dried wheat seeds are smeared with 50 ml of a flowable formulation containing any of the compounds (1) to (44) prepared as in Formulation example 8, to obtain treated seeds.

### Seed Treatment Example 9

A powder agent containing any of the compounds (1) to (44) prepared as in Formulation example 9 is used for powder coating treatment in an amount of 50 g per 10 kg of dried corn seeds to obtain treated seeds.

### Seed Treatment Example 10

A powder agent containing any of the compounds (1) to (44) prepared as in Formulation example 9 is used for powder coating treatment in an amount of 40 g per 10 kg of dried cotton seeds to obtain treated seeds.

An effect of the composition of the present invention on control of pests will be illustrated in examples below.

### Test Example 1

### Insecticidal Effect on Spodoptera litura by Bait Crop Immersion Treatment

To 10 mg of the compound (2), (22) or (24) was added 0.2 ml of acetone containing 5% of Tween 20 (product name, registered trademark, manufactured by Kao Corporation) to cause dissolution, and the solution was diluted with a 5,000-fold diluted solution of a spreading agent (product name: Dine (registered trademark), manufactured by Sumitomo Chemical Garden Products Inc.) to prepare a diluted liquid of the compound (2), (22) or (24). A commercially available clothianidin water-soluble agent (product name: Dantotsu (registered trademark) water-soluble agent, manufactured by Sumitomo Chemical Co., Ltd.) was diluted with a 5,000-fold diluted solution of a spreading agent (product name: Dine (registered trademark), manufactured by Sumitomo Chemical Garden Products Inc.) to prepare a diluted liquid of clothianidin. These diluted liquids were mixed to obtain given concentration, preparing a test solution. In the test solution, one true leaf of Brassicae oleracea at 7 to 8-leaves stage was immersed for several seconds, and air-dried. After drying of the test solution, this leaf was placed in a polyethylene cup (200-ml volume), and ten fourth-instar larvae of Spodoptera litura were released. The cup was stored in a constant temperature breeding room (25° C.), and the number of dead larvae was counted 2 days after, and the mortality was determined by the following formula.

Mortality(%)=(dead larvae number/tested larvae number)×100

The results are shown in Table 3.

TABLE 3

| | Test compounds | Mortality (%) |
|---|---|---|
| Example 1 | compound (2) 0.8 ppm + | 80 |
| | clothianidin 2.56 ppm | |
| Example 2 | compound (24) 0.2 ppm + | 90 |
| | clothianidin 4 ppm | |

By use of the compound (2) or (24) with clothianidin in admixture, a higher insecticidal effect is exerted on Spodoptera litura than in the case of single use of them, revealing a synergistic effect by mixing.

### Test Example 2

### Insecticidal Effect on Spodoptera litura by Bait Crop Immersion Treatment

The mortality was measured in the same manner as in Test Example 1 excepting that a thiamethoxam granule water-soluble agent (product name: Aktara (registered trademark) granule water-soluble agent, manufactured by Syngenta Japan K.K.) was used instead of the commercially available clothianidin water-soluble agent, in Test Example 1. The results are shown in Table 4.

TABLE 4

| | Test compounds | Mortality (%) |
|---|---|---|
| Example 3 | compound (2) 0.8 ppm + | 90 |
| | thiamethoxam 1.6 ppm | |
| Example 4 | compound (2) 0.8 ppm + | 80 |
| | thiamethoxam 0.53 ppm | |

By use of the compound (2) and thiamethoxam in admixture, a higher insecticidal effect is exerted on Spodoptera litura than in the case of single use of them, revealing a synergistic effect by mixing.

### Test Example 3

### Insecticidal Effect on Spodoptera litura by Bait Crop Immersion Treatment

The mortality was measured in the same manner as in Test Example 1 excepting that an imidacloprid flowable (product name: Admire (registered trademark) flowable, manufactured by Bayer CropScience) was used instead of the commercially available clothianidin water-soluble agent, in Test Example 1. The results are shown in Table 5.

TABLE 5

| | Test compounds | Mortality (%) |
|---|---|---|
| Example 5 | compound (2) 0.8 ppm + | 100 |
| | imidacloprid 3.2 ppm | |
| Example 6 | compound (22) 0.4 ppm + | 60 |
| | imidacloprid 1.6 ppm | |

By use of the compound (2) or (22) with imidacloprid in admixture, a higher insecticidal effect is exerted on Spodoptera litura than in the case of single use of them, revealing a synergistic effect by mixing.

### Test Example 4

### Insecticidal Effect on Plutella xylostella by Bait Crop Immersion Treatment

To 10 mg of the compound (2), (22) or (24) was added 0.2 ml of acetone containing 5% of Tween 20 (product name, registered trademark, manufactured by Kao Corporation) to cause dissolution, and the solution was diluted with a 5,000-fold diluted solution of a spreading agent (product name: Dine (registered trademark), manufactured by Sumitomo Chemical Garden Products Inc.) to prepare a diluted liquid of the compound (2), (22) or (24). A commercially available clothianidin water-soluble agent (product name: Dantotsu (registered trademark) water-soluble agent, manufactured by Sumitomo Chemical Co., Ltd.) was diluted with a 5,000-fold diluted solution of a spreading agent (product name: Dine (registered trademark), manufactured by Sumitomo Chemical Garden Products Inc.) to prepare a diluted liquid of clothianidin. These diluted liquids were mixed to obtain given concentration, preparing a test solution. In the test solution, one true leaf of Brassicae oleracea at 7 to 8-leaves stage was immersed for several seconds, and air-dried. After drying of the test solution, this leaf was placed in a polyethylene cup (200-ml volume), and ten third-instar larvae of Plutella xylostella were released. The cup was stored in a constant temperature breeding room (25° C.), and the number of dead larvae was counted 2 days after, and the mortality was determined by the following formula.

Mortality(%)=(dead larvae number/tested larvae number)×100

The results are shown in Table 6.

TABLE 6

| | Test compounds | Mortality (%) |
|---|---|---|
| Example 7 | compound (2) 0.2 ppm + | 70 |
| | clothianidin 0.32 ppm | |
| Example 8 | compound (2) 0.2 ppm + | 80 |
| | clothianidin 0.64 ppm | |

By use of the compound (2) and clothianidin in admixture, a higher insecticidal effect is exerted on Plutella xylostella than in the case of single use of them, revealing a synergistic effect by mixing.

### Test Example 5

### Insecticidal Effect on Plutella xylostella by Bait Crop Immersion Treatment

The mortality was measured in the same manner as in Test Example 4 excepting that a nitenpyram water-soluble agent (product name: Best Guard (registered trademark) water-soluble agent, manufactured by Sumitomo Chemical Co., Ltd.) was used instead of the commercially available clothianidin water-soluble agent, in Test Example 4. The results are shown in Table 7.

TABLE 7

| | Test compounds | Mortality (%) |
|---|---|---|
| Example 9 | compound (2) 0.2 ppm + | 80 |
| | nitenpyram 0.4 ppm | |
| Example 10 | compound (2) 0.2 ppm + | 100 |
| | nitenpyram 0.8 ppm | |
| Example 11 | compound (22) 0.8 ppm + | 70 |
| | nitenpyram 1.6 ppm | |

By use of the compound (2) or (22) with nitenpyram in admixture, a higher insecticidal effect is exerted on Plutella xylostella than in the case of single use of them, revealing a synergistic effect by mixing.

### Test Example 6

### Insecticidal Effect on Plutella xylostella by Bait Crop Immersion Treatment

The mortality was measured in the same manner as in Test Example 4 excepting that a thiamethoxam granule water-soluble agent (product name: Aktara (registered trademark) granule water-soluble agent, manufactured by Syngenta Japan K.K.) was used instead of the commercially available clothianidin water-soluble agent, in Test Example 4. The results are shown in Table 8.

TABLE 8

| | Test compounds | Mortality (%) |
|---|---|---|
| Example 12 | compound (2) 0.1 ppm + | 80 |
| | thiamethoxam 0.4 ppm | |
| Example 13 | compound (2) 0.2 ppm + | 90 |
| | thiamethoxam 1.6 ppm | |

By use of the compound (2) and thiamethoxam in admixture, a higher insecticidal effect is exerted on Plutella xylostella than in the case of single use of them, revealing a synergistic effect by mixing.

### Test Example 7

### Insecticidal Effect on Plutella xylostella by Bait Crop Immersion Treatment

The mortality was measured in the same manner as in Test Example 4 excepting that an imidacloprid flowable (product name: Admire (registered trademark) flowable, manufactured by Bayer CropScience) was used instead of the commercially available clothianidin water-soluble agent, in Test Example 4. The results are shown in Table 9.

TABLE 9

| | Test compounds | Mortality (%) |
|---|---|---|
| Example 14 | compound (2) 0.2 ppm + | 90 |
| | imidacloprid 0.8 ppm | |
| Example 15 | compound (24) 0.8 ppm + | 80 |
| | imidacloprid 0.2 ppm | |

By use of the compound (2) or (24) with imidacloprid in admixture, a higher insecticidal effect is exerted on Plutella xylostella than in the case of single use of them, revealing a synergistic effect by mixing.

### INDUSTRIAL APPLICABILITY

According to the present invention, it becomes possible to provide a pest controlling composition showing an excellent effect for controlling pests.

1. A pest controlling composition comprising, as active ingredients, the following (A) and (B):
(A) an amide compound of the formula (I): 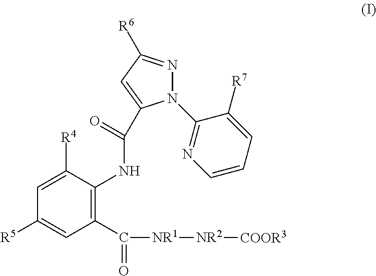
wherein, R¹ represents a C1-C6 alkyl group optionally substituted with at least one halogen atom, R² represents a hydrogen atom or a C1-C6 alkyl group optionally substituted with at least one halogen atom, R³ represents a C1-C6 alkyl group optionally substituted with at least one halogen atom, a C3-C6 alkoxyalkyl group optionally substituted with at least one halogen atom, a C3-C6 alkenyl group optionally substituted with at least one halogen atom or a C3-C6 alkynyl group optionally substituted with at least one halogen atom, R⁴ represents a halogen atom or a C1-C6 alkyl group optionally substituted with at least one halogen atom, R⁵ represents a hydrogen atom, a halogen atom, a cyano group or a C1-C6 alkyl group optionally substituted with at least one halogen atom, R⁶ represents a hydrogen atom, a halogen atom, a cyano group, a C1-C6 alkyl group optionally substituted with at least one halogen atom, a C1-C6 alkoxy group optionally substituted with at least one halogen atom, a C1-C6 alkylthio group optionally substituted with at least one halogen atom, a C1-C6 alkylsulfinyl group optionally substituted with at least one halogen atom or a C1-C6 alkylsulfonyl group optionally substituted with at least one halogen atom, and R⁷ represents a halogen atom or a C1-C6 alkyl group optionally substituted with at least one halogen atom; and
(B) a neonicotinoid compound.

2. The pest controlling composition according to claim 1, wherein R¹ is an ethyl group, R² is a hydrogen atom, methyl group or ethyl group, R³ is a methyl group or ethyl group, R⁴ is a halogen atom or methyl group, R⁵ is a halogen atom or cyano group, R⁶ is a halogen atom or trifluoromethyl group and R⁷ is a halogen atom, in the formula (I).

3. The pest controlling composition according to claim 1, wherein R¹ is an ethyl group, R² is a hydrogen atom, R³ is a methyl group, R⁴ is a methyl group, R⁵ is a cyano group, R⁶ is a bromine atom and R⁷ is a chlorine atom, in the formula (I).

4. The pest controlling composition according to claim 1, wherein R¹ is an ethyl group, R² is an ethyl group, R³ is a methyl group, R⁴ is a bromine atom, R⁵ is a bromine atom, R⁶ is a bromine atom and R⁷ is a chlorine atom, in the formula (I).

5. The pest controlling composition according to claim 1, wherein R¹ is an ethyl group, R² is a hydrogen atom, R³ is a methyl group, R⁴ is a bromine atom, R⁵ is a bromine atom, R⁶ is a bromine atom and R⁷ is a chlorine atom, in the formula (I).

6. The pest controlling composition according to claim 1, wherein the weight ratio of the component (A) to the component (B) is 10:90 to 90:10.

7. The pest controlling composition according to claim 1, wherein the neonicotinoid compound is at least one compound selected from the group consisting of clothianidin, nitenpyram, thiamethoxam, imidacloprid, acetamiprid, dinotefuran and thiacloprid.

8. The pest controlling composition according to claim 1, wherein the neonicotinoid compound is clothianidin or nitenpyram.

9. A pest controlling method comprising applying an effective amount of the pest controlling composition as defined in claim 1 to a pest, a habitat of a pest, or a plant body to be protected from damage by a pest.

10. A pest controlling method comprising applying an effective amount of the pest controlling composition as defined in claim 1 to a seed, seed tuber, bulb or parts around them of a plant to be protected from damage by a pest.
